(19) United States
(12) Patent Application Publication
(10) Pub. No.: US 2012/0255584 A1
(43) Pub. Date: Oct. 11, 2012

(54) METHOD OF CLEANING CYLINDERS OR ROLLS

(76) Inventors: Andreas Gramer, Solingen (DE); Peter De Kock, Oberhausen (DE); Rolf Brisberger, Spielberg (AT)

(21) Appl. No.: 13/446,132

(22) Filed: Apr. 13, 2012

Related U.S. Application Data
(63) Continuation-in-part of application No. 11/664,901, filed on Apr. 5, 2007, now abandoned.

(30) Foreign Application Priority Data
Oct. 6, 2004 (DE) 10 2004 048 619.0

(51) Int. Cl. B08B 3/02

(52) U.S. Cl. 134/36

(57) ABSTRACT

A method of cleaning cylinders (5) and/or rolls (5), e.g., working rolls (5) in a rolling stand, wherein a liquid is sprayed onto the cylinders (5) at high pressure through several nozzles (D1-Dn) of a number of nozzles (D1-Dn) stationary arranged in and/or on a nozzle beam (10), with at least one on-off valve being associated with each nozzle (D1-Dn), and one or several nozzle(s) (D1-Dn) are sequentially switched on and off one after another starting from one end of the nozzle beam.

### RELATED APPLICATIONS

This application is a continuation-in-part of application Ser. No. 11/664,901 filed Apr. 5, 2007 which is a national stage application of International application PCT/EP2005/009780 filed Sep. 12, 2005 that claims priority of German application DE 10 2004 048 619.0 filed Oct. 6, 2004, the three applications being incorporated herein by reference thereto.

### BACKGROUND OF THE INVENTION

1. Field of the Invention

The invention relates to a method of cleaning cylinders and/or rolls, e.g., working rolls in a rolling stand, which are used for producing a rolled stock such as strips or slabs, wherein a liquid is sprayed onto the cylinders at high pressure through several nozzles.

2. Description of the Prior Art

Cylinder and/or rolls are used in numerous locations of a plant. Their surfaces become dirty and should be cleaned periodically or continuously.

Cleaning of rolling mill rolls with fluid sprayed at high pressure is known. JP-05 069 028A, JP-06 344 005A, JP-10 058 002A, JP-6 285 516, JP-09 262 607A, JP-08 155 509A, JP-08 174 005A, JP-07 068 301A, JP-05 042 309A, JP-05 317 907, JP-05 337 52A, and JP-58 199 604A, show corresponding installations.

EP 0385 097 A2 discloses that in rolling mill technology, wet skin-pass rolling is known, wherein with water or water-like additives, a sliding film is formed between working rolls and backup rolls. Simultaneously, the rolls should be kept clean.

U.S. Pat. No. 5,460,023 describes a method of and an apparatus for cleaning of rolls with a multiplicity of nozzles arranged on a nozzle beam. For a better cleaning of the entire surface of a roll, the nozzle beam is displaced axially. Thereby, each separate nozzle travels a predetermined path over the surface of a roll. Axial displacement of the nozzle beam is effected with a hydraulic cylinder.

EP 09 95 504 B1 discloses a method of cleaning cylinders and/or rolls in strip casting installations, rolling mills, and/or strip treating lines, in particular, skin-pass mills or similar after-treatment mills for producing or treatment of metal strips, according to which cylinders and/or rolls are subjected to cleaning fluid from at least one cleaning nozzle the distance of which from the cylinder surface or the roll surface of the concerned cylinder or roll is adjusted or controlled to a predetermined value, with the cleaning nozzle reciprocating with adjusted or controlled oscillating speed along the concerned cylinder and/or roll dependent on the strip speed and/or strip material and/or strip surface.

In known installations, one or several nozzles are displaced along the cylinder. Therefore, the nozzle or nozzles are arranged, e.g., on a traveling drive unit with slides, wherein each nozzle must be supplied with cleaning fluid by a displaceable supply-or feeding conduit. Further, a movable cabling is necessary. The regulation of the oscillating speed is expensive, as of the distance of nozzles from to-be-cleaned rolls.

Accordingly, an object of the invention is a method of and an apparatus for cleaning cylinders/rolls which simpler in operation and design, with increased cleaning effect and prevention of surfaces damages.

### SUMMARY OF THE INVENTION

This object is achieved according to the invention, by providing a method for cleaning working rolls of a rolling stand and including providing an apparatus for cleaning a working roll and having a beam extending in a longitudinal direction of a cleanable roll, a plurality of nozzles for spraying a cleaning liquid under pressure onto the roll, arranged in a row extending in a longitudinal direction of the cleanable roll from one end of the nozzle beam to another end of the nozzle beam and supported on the nozzle beam, and a plurality of on-off valves. A single on-off valve is used for switching nozzles of each pair of adjacent nozzles of following one another, in the longitudinal direction of the cleanable roll, pairs of adjacent nozzles. Upon starting a cleaning process each pair of adjacent nozzles is switched on and off sequentially and simultaneously starting from the one end of the beam.

The decisive advantage of the inventive method consists in that no mechanical movement in the roll longitudinal direction takes place and, therefore, no cable towing apparatus to supply conduits is needed. The electricity necessary for turning on and off the nozzle beam and switching on and off separate nozzles is reduced. During cleaning operation, the 100% of the circumference of the cylinder, or the roll is treated during a cleaning period, so that no dirty spirals appear.

Each cleaning period starts at the same cylinder or roll end, and the intervals between the cleaning periods are the same.

With a rotational angle of the nozzle of 17° and a circumference corresponding to the diameter of 60 mm, the necessary distance to the roll surface amounts to about 200 mm. If an effective diameter of 50 mm is used, with a maximum strip width of 2,100 mm, 42 nozzles are provided per nozzle beam. With a simultaneous activation of two nozzles with a single valve, 21 valves are required. In a preferred embodiment, the nozzles can be arranged with an offset. At a VE-water consumption of 1/min per nozzle and a sequential control of respective two by two nozzles above the rolling stock and two by two nozzles beneath the rolling stock, the total volumetric flow amounts to about 90 1/min.

A cleaning period is determined by two revolution of the cylinder/roll per each nozzle pair, so that the nozzles (n) in the nozzle beam clean the cylinder roller at a second revolution and then are returned off, and the nozzles (n+1) start cleaning of the cylinder/roll during a first revolution. When the nozzles (n) are turned off, the nozzles (n+2) are turned on.

E.g., with a working roll diameter of 620 mm, the length of the rolling stock per nozzle sequence is about 4 m, at a diameter of 560 mm, 3.5 m, and at a diameter of 400 mm, about 3 m. At average roll speed of 100 m/min in a skin-pass stand, the operational period is about 2 sec/nozzle pair and for the entire roll 21+1 sec/roll. The total length of the rolled stock during cleaning is about 37 m.

Embodiments of the invention will be now described in detail with reference to schematic drawings.

### BRIEF DESCRIPTION OF THE DRAWINGS

The drawings show:

FIG. 1 a timed course of the nozzle discharge,

FIG. 2 a view of a spray picture,

FIG. 3a a schematic view of an arrangement in which a single valve controls a single nozzle,

FIG. 3b a schematic view of an arrangement wherein a single valve controls two nozzles, and

FIG. 4 a schematic view illustrating the apparatus according to the present invention in which each of the plurality of valve controls two adjacent nozzles.

### DETAILED DESCRIPTION OF THE PREFERRED EMBODIMENTS

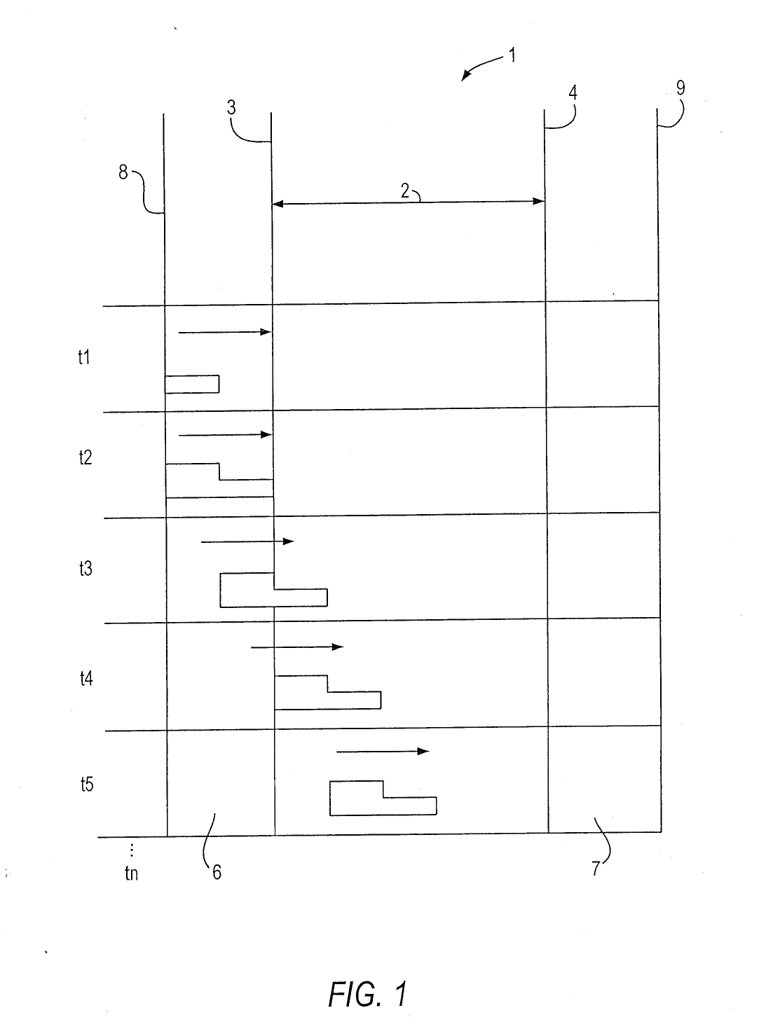

FIG. 1 shows a timed course of nozzle discharge during cleaning of a cylinder/roll.

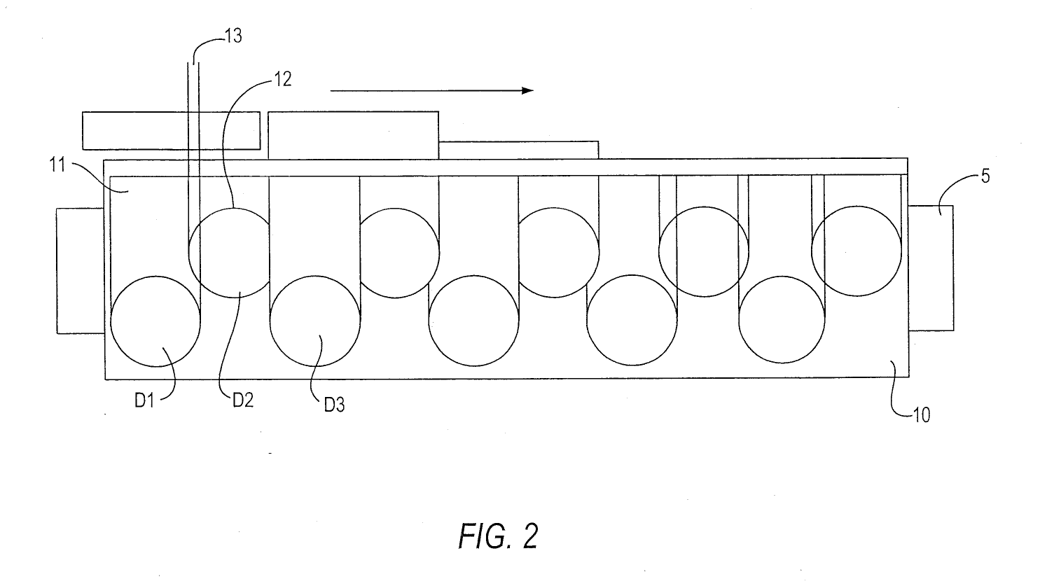

A rolled stock, e.g., a metal strip, with a width 2 has a left edge 3 and a right edge 4. A working roll 5 (see FIG. 2) has a length that is greater than a width of the metal strip so that the collar regions 6, 7 of the working roll have no contact with the metal strip 1. The working roll 5 has a left barrel border 8 and a right barrel border 9.

In the shown embodiment, firstly, a left nozzle D1 of the nozzle beam 10 (see (FIG. 2) opens at time t1. After a predetermined time period, at time t2, additionally, a nozzle D2, which is located rightwardly adjacent to the nozzle D1, opens. After a subsequent time period, at a time t3, the nozzle D1 is turned off, and the next following nozzle D3 opens. This process is repeated as long until the right barrel border 9 of the working roll 5 is reached. The next cleaning period can then follow immediately thereafter when the nozzle D1 opens and then the nozzle 2.

Dependent on the degree of contamination of the cylinders/rolls 5, the next cleaning period follows with a time delay. The delay can follow automatically and have the same time period. It is also contemplated to start the cleaning periods additionally or always manually.

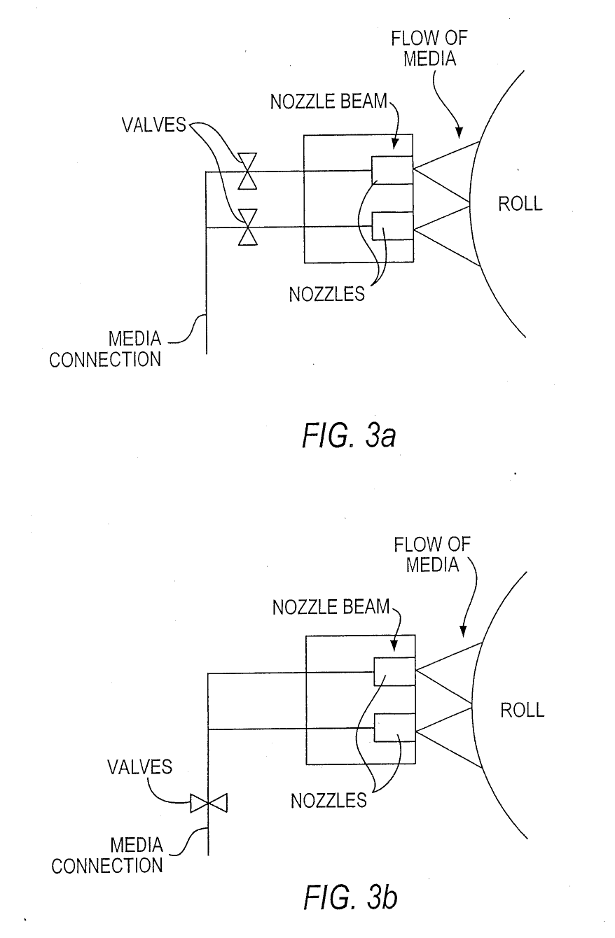

FIG. 2 shows a nozzle beam 10 with ten nozzles (D1-D10). The spray picture 11 of the nozzle D1 overlaps the spray picture 12 of the nozzle D2 in a region 13. The following nozzles show the same overlap. To better form the overlaps, which determine the degree of cleaning of the cylinder/roll, the adjacent nozzles D1, D2, e.g., are arranged on the nozzle beam 10 with offset. Each nozzle D1 or each nozzle pair D1, D2 is controlled by a valve as shown in FIGS. 3a and 3b, respectively.

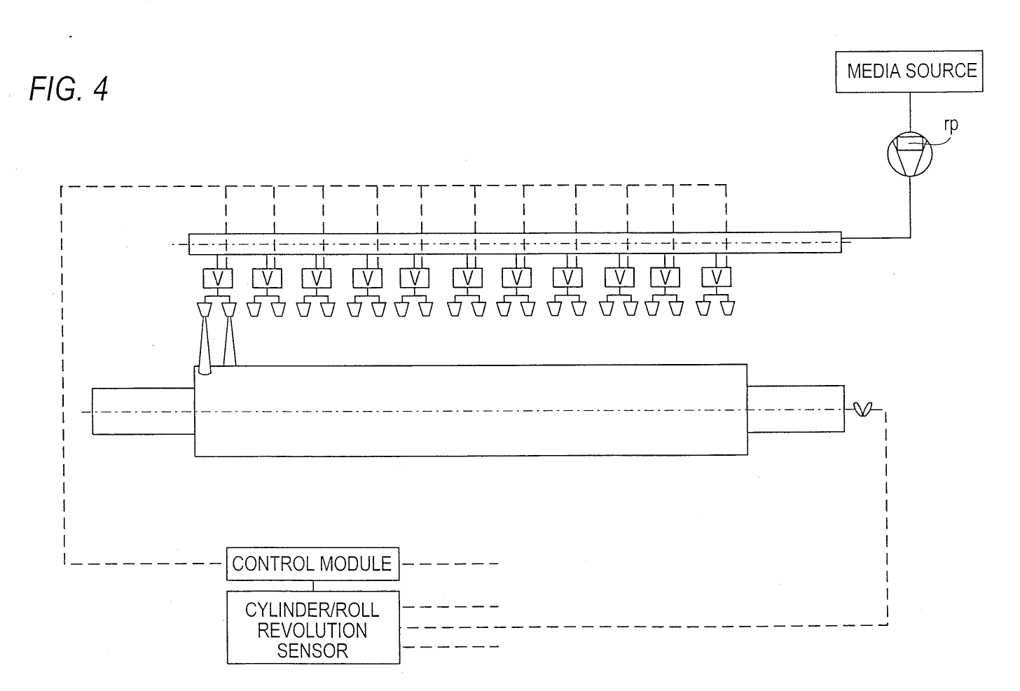

FIG. 4 illustrates the inventive apparatus in which each adjacent pair of nozzles is controlled by a single valve, with the actuation of the valves being effected by a control module in accordance with revolutions of the roll.

With a single valve controlling a pair of nozzles D1, D2, the first pair of the nozzle beam 10 opens at time t1. After a predetermined time period, at time t2, additionally, the second pair of nozzles D1, D2 opens. After a subsequent time period, at a time t3, the first nozzle pair is turned off, and the next following nozzle pair opens. This process is repeated as long until the right barrel border 9 of the working roll 5 is reached.

What is claimed is:

1. A method of cleaning working rolls of a rolling stand, comprising the steps of providing an apparatus for cleaning a working roll and including a beam extending in a longitudinal direction of a cleanable roll, a plurality of nozzles for spraying a cleaning liquid under pressure onto the roll, supported on the nozzle beam and arranged in a row extending in a longitudinal direction of the cleanable roll from one end of the nozzle beam to another end of the nozzle beam, with the nozzles being arranged in pairs of adjacent nozzles following one another in the longitudinal direction of the cleanable roll, and a plurality of on-off valves with a single on-of valve being used for switching each pair of adjacent nozzles; and upon staring a cleaning process, sequentially and simultaneously switching each pair of adjacent nozzles on and off, starting from the one end of the beam.

2. A method according to claim 1, wherein a third nozzle pair, in the longitudinal direction of the cleanable roll, of a set of three, following one another nozzle pairs, is switched on when a first nozzle pair of the set of the three following one another nozzle pairs is switched off.

3. A method according to claim 1, comprising the step of starting a new cleaning period immediately after an end of the working roll (5) opposite the another end of the nozzle beam has been cleaned.

4. A method according to claim 3, wherein a further cleaning period following the new cleaning period is carried out with a time delay.

5. A method according to claim 1, wherein switching of respective pairs of at least two adjacent nozzles on and off depends on a roll speed.

6. A method of cleaning working rolls of a rolling stand, comprising the steps of providing an apparatus for cleaning a working roll and including a beam extending in a longitudinal direction of a cleanable roll, a plurality of nozzles for spraying a cleaning liquid under pressure onto the roll, arranged in a row extending in a longitudinal direction of the cleanable roll from one end of the nozzle beam to another end of the nozzle beam and supported on the nozzle beam, and a plurality of on-off valves for switching respective nozzles (D1-Dn) on and off; and upon starting a cleaning process, sequentially switching the nozzles on and off starting from the one end of the nozzle beam to another end of the nozzle beam, with every third nozzle, in the longitudinal direction of the cleanable roll, of a set of three, following one another, nozzles being switched on when a respective first nozzle of the set of three following one another nozzles is switched off.

7. A method according to claim 6, comprising the step of starting a new cleaning period immediately after an end of the working roll (5) opposite the another end of the nozzle beam has been cleaned.

8. A method according to claim 6, wherein a further cleaning period following the new cleaning period is carried out with a time delay. A method according to claim 6, wherein switching of nozzles on and off depends on a roll speed.
